(19) United States
(12) Patent Application Publication
(10) Pub. No.: US 2025/0373478 A1
(43) Pub. Date: Dec. 4, 2025

(54) METHOD FOR REDUCING THE PEAK-TO-AVERAGE POWER RATIO OF AN OFDM-TYPE SIGNAL, COMPUTER PROGRAM PRODUCTS AND CORRESPONDING DEVICES

(71) Applicant: COMMISSARIAT A L'ENERGIE ATOMIQUE ET AUX ENERGIES ALTERNATIVES, Paris (FR)

(72) Inventors: Rafik ZAYANI, Grenoble Cedex 9 (FR); Benoît MISCOPEIN, Grenoble Cedex 9 (FR); Jean-Baptiste DORE, Grenoble Cedex 9 (FR)

(73) Assignee: COMMISSARIAT A L'ENERGIE ATOMIQUE ET AUX ENERGIES ALTERNATIVES, Paris (FR)

(21) Appl. No.: 18/876,736

(22) PCT Filed: Jun. 27, 2023
(86) PCT No.: PCT/FR2023/050974

§ 371 Date: Dec. 19, 2024

(30) Foreign Application Priority Data
Jun. 27, 2022 (FR) 2206366

(51) Int. Cl. H04L 27/26; H04B 7/0413; H04L 5/00

(52) U.S. Cl. CPC H04L 27/2623; H04L 5/0007; H04L 27/2618; H04B 7/0413

(57) ABSTRACT

The invention relates to a method for reducing the peak-to-average power ratio of an OFDM-type signal comprising N subcarriers. The signal results from stacking M spatial components that are each transmitted by a respective antenna of a radiofrequency transmitter to a plurality of receivers. Such a method uses spatial coding of the distortion signal associated with clipping the OFDM signal transmitted by the transmitter so that the distortion signal in question is transmitted in the direction of a receiver for which the estimated propagation channel, between the receiver in question and the transmitter, corresponds to a path loss greater than a predetermined threshold.

### FIELD OF THE INVENTION

The field of the invention is that of data transmission via the use of a radiofrequency signal of the OFDM (“Orthogonal Frequency Division Multiplexing”) type transmitted via a plurality of antennas of a radiofrequency transmitter to a plurality of receivers.

The invention relates more particularly to a method for reducing the peak-to-average power ratio of such a signal.

Such a waveform is used in many fields related to data transmission by radiofrequency links. The invention thus has applications, in particular, but not exclusively, in the field of mobile telephony (e.g. 4G, 5G or beyond (6G) networks as defined by the 3GPP (for “3rd Generation Partnership Project”)) or wireless local area networks WLAN (e.g. using WiFi), high-speed wireless Internet access (WiMAX), asymmetric digital links (xDSL), point-to-multipoint wireless links, etc.

### Prior Art and its Drawbacks

In the remainder of this document, the focus has been placed more particularly on describing an existing problem in the technological field of cell-free massive MIMO (for ‘Multiple-Input Multiple-Output’), or CF-mMIMO (for “cell-free massive MIMO”), and more particularly in the technological field of scalable CF-rnMIMO. The invention is of course not limited to this particular field of application, but is of interest for the generation of any OFDM-type communications signal transmitted via plurality of antennas of a radiofrequency transmitter to a plurality of receivers (e.g. receivers of user terminals).

Over the last decades, the exponential growth of mobile data traffic has been made possible by the densification of the network infrastructure, which can be ensured:
(i) by increasing the cellular density. Such an approach is known as an ultra-dense network; and/or
(ii) by adopting a large number of active antennas per access point, or AP. Such an approach is known as massive MIMO, or mMIMO.

Nevertheless, cellular densification and mMIMO technology have fundamental limitations. In particular, inter-cell interference and large variations in quality of service make such technologies unable to cope with the challenges of next-generation networks (e.g. 6G) regarding the increase in the data rate for the user terminals and low energy consumption.

To this end, a new wireless technology has recently attracted increasing attention, the CF-mMIMO technology. The main property of CF-mMIMO technology is that there are many geographically distributed APs, but the coverage area is not divided into disjoint cells. Indeed, as illustrated in [FIG. 1a], according to the CF-mMIMO technology, a single system 120 centrally groups together the necessary means (e.g. with regard to power of computing, of data storage, etc.) for the operation of the different APs 110. In this manner, the CF-mMIMO technology has two main characteristics which are:
(i) the operating regime with more APs 110 than user terminals 100 as well as the operation of the physical layer inspired by the recent progress in the mMIMO field; and
(ii) each terminal 100 is served by all surrounding APs for a “cell-free” operation.

However, the original version of CF-mMIMO technology was not scalable, that is to say that the front-end capacity and computational complexity grow exponentially with the number of terminals 100. This is because all APs 110 are connected to a central processing unit, within the system 120, which is responsible for coordinating and processing the signals from all terminals 100. Very recently, a new scalable version of CF-mMIMO (or scalable CF-mMIMO), has been introduced, in the article by E. Bjornson and L. Sanguinetti, “Scalable cell-free massive mimo systems,” IEEE Transactions on Communications, vol. 68, no. 7, pp. 4247-4261, 2020, where the fully distributed processing is adopted as illustrated in [FIG. 1b]. In particular, new scalable spatial precoding and combination schemes 30 as well as channel estimation, power allocation, AP clustering methods can be introduced, obtaining very good advantages for the CF-mMIMO technique. Moreover, the use of OFDM signals allows managing frequency selective channels in a simple and robust manner. Thus, a CF-mMIMO technology using such OFDM signals for data transmission seems to be a very promising combination to meet the ever increasing demands regarding data throughput.

However, CF-mMIMO systems based on OFDM signal transmission have a high peak-to-average power ratio (PAPR) for the transmitted signals. However, to be commercially viable, a CF-mMIMO system based on OFDM signal transmission requires that the APs 110 are deployed using energy-efficient and low-cost hardware. Consequently, it is essential to reduce the PAPR of such CF-mMIMO systems to allow cost-effective and energy-efficient deployments of APs 110.

The PAPR reduction problem has been studied for a long time, the first method proposed for OFDM dates back to 1999. Then, some methods have been introduced to improve the energy efficiency, such as tone reservation, or TR, selective mapping, or SLM, partial transmission sequence, or PTS, active constellation extension, or ACE, iterative coding and clipping with filtering. These methods, which were initially proposed for SISO (Single-Input Single-Output) and conventional MIMO-OFDM implementations, can unfortunately provide a moderate PAPR reduction that does not meet the high energy efficiency requirements for massive 6G networks based on a MIMO technology. In addition, the bottlenecks of these methods are related to their respective drawbacks such as the increase in average power, the loss of spectral efficiency due to the reservation of some subcarriers, a high computational load and a high latency. Therefore, they are not suitable for massive MIMO systems.

In this regard, more efficient techniques have been proposed for collocated massive MIMO-OFDM systems, such as e.g. the Fast Truncation Algorithm, or FITRA, or the Alternative Direction Method of Multipliers, or ADMM, assisted by perturbation. More recently, joint multi-user precoding and PAPR reduction schemes have been studied.

However, all these techniques are limited to traditional and/or collocated massive MIMO systems. Indeed, in the case of massive systems, many degrees of freedom can be exploited to effectively reduce the PAPR by equipping the AP 110 with a large number of antennas relative to the number of served user terminals. For example, the article by Rafik Zayani and Daniel Roviras: “Low-complexity linear precoding for Iow-PAPR massive MU-MIMO-OFDM downlink systems”, International Journal of Communication Systems, Wiley, 2021, 34 (12), uses the degrees of freedom related to the large number of antennas in order to transmit the distortion signal related to a clipping of the OFDM signal transmitted by the AP 110 in a direction in which no terminals 100 are present. However, in the perspective of an economical implementation as considered for the scalable CF-mMIMO, a reduced number of antennas, relative to a massive MIMO technique, must be considered. In such a configuration, the number of terminals 100 connected to a given AP 110 may be greater than the number of transmit antennas of the AP 110 in question. In such a configuration, there are no more free degrees of freedom to exploit and the approach outlined in the aforementioned article cannot be applied.

There is thus a need for a technique for reducing the peak-to-average power ratio of an OFDM-type signal having improved performance relative to the known techniques. Such a technique must in particular be adapted to the scalable CF-mMIMO context in which the number of UEs 100 connected to the same AP 110 may be greater than the number of transmit antennas of the AP 110 in question.

### DISCLOSURE OF THE INVENTION

In one embodiment of the invention, a method for reducing the peak-to-average power ratio of an OFDM-type signal comprising N subcarriers is proposed. The signal results from stacking M spatial components that are each transmitted by a respective antenna of a radiofrequency transmitter to a plurality of receivers. According to such a method, an electronic device executes:
an obtaining of M clipped OFDM symbols each intended to be a temporal portion of a spatial component transmitted by a respective antenna of the transmitter. The obtaining comprises, for at least one antenna of the transmitter:
a generation of an OFDM symbol by implementing an inverse Fourier transform applied to an input vector depending on modulation symbols, each component of the input vector being intended to be conveyed by a corresponding subcarrier of a spatial component of the OFDM-type signal; and
a clipping of the OFDM symbol delivering a clipped OFDM symbol intended to be a temporal portion of the spatial component transmitted by the antenna.

The generation and the clipping repeated for each antenna of the transmitter delivering the M clipped OFDM symbols,

According to the method, the electronic device executes, for at least one given antenna of the transmitter:
a Fourier transformation of an error vector depending on a difference between the clipped OFDM symbol and the OFDM symbol associated with the given antenna, delivering a transformed error vector of N error signals. The Fourier transformation which is repeated for each antenna of the transmitter delivers M transformed error vectors of N error signals.

According to the method, the electronic device executes, for at least one given subcarrier:
a concatenation of the error signals associated with the given subcarrier in each of the M transformed error vectors delivering an error vector, called subcarrier error vector, of M error signals. Each error signal in the subcarrier error vector being associated with a respective antenna; and
a projection of the subcarrier error vector delivering a vector of M signals for reducing the peak-to-average power ratio associated with the given subcarrier. Each peak-to-average power ratio reduction signal in said vector of M reduction signals being associated with a respective antenna.

According to the method, the electronic device executes a new implementation of said obtaining of M clipped OFDM symbols to generate M updated clipped OFDM symbols, in which the generation, for at least one antenna of the transmitter, of an OFDM symbol implements the inverse Fourier transformation applied to an updated input vector. The updated input vector being a function of N new modulation symbols, the peak-to-average power ratio reduction signal of the vector of M reduction signals corresponding to said antenna and associated with the given subcarrier being added to the new modulation symbol intended to be conveyed by said given subcarrier in the updated input vector;

According to the method, the projection implements a spatial coding of said M error signals of the subcarrier error vector based on an estimated propagation channel between the receivers and the transmitter so that the distortion signal related to the difference between the clipped OFDM symbols and the OFDM symbols is transmitted by the transmitter in at least one direction of a receiver, called weak receiver, for which the estimated propagation channel corresponds to a propagation loss which is greater than a predetermined threshold. The projection implements an operator Vin of the spatial coding being expressed as the identity operator from which a normalized modified spatial coding operator is subtracted. The normalized modified spatial coding operator being a function of a composition between a modified spatial precoding operator and an operator modeling the estimated propagation channel between the transmitter and the receivers. The modified spatial precoding operator depends on an operator, called receivers operator, from which a regularization operator is subtracted. The receivers operator depends s on a composition between an operator modeling the estimated propagation channel between the receivers and the transmitter and the operator modeling an estimated propagation channel between the transmitter and the receivers.

Each diagonal element of the receivers operator is representative of a power received by the corresponding receiver. The regularization operator is of the diagonal type, each diagonal element of said regularization operator is associated with a corresponding receiver, an amplitude of each diagonal element of the regularization operator allows controlling the level of distortion related to the difference between the OFDM symbols and the clipped OFDM symbols transmitted in the direction of the corresponding receiver.

Thus, the invention proposes a new and inventive solution for reducing the peak-to-average power ratio of an OFDM-type signal, e.g. in a CF-mMIMO context.

More particularly, it is proposed to use a spatial coding of the distortion signal related to the clipping so as to transmit the signal in question as a priority towards the receivers furthest from the AP incorporating the considered transmitter, i.e. the weak receivers. Indeed, it is probable that in an AP-dense system, as in a system of the scalable CF-mMIMO type, such weak receivers are located in the vicinity of another AP. It can thus be assumed that the weak receivers from the point of view of a given AP are “strong” from the point of view of another AP. It is thus probable that the transmission of the distortion related to the clipping to the weak receivers will not penalize the overall performances for the weak receivers, the latter also receiving their data via another AP.

Moreover, transmitting the distortion signal to receivers connected to the considered AP rather than in a direction in which no receiver is present allows overcoming the problem of the absence of degrees of freedom available when the number of receivers connected to the AP incorporating the transmitter in question is greater than the number of transmit antennas of this AP. The present technique is thus particularly adapted to a system of the scalable CF-mMIMO type.

In some embodiments, said at least one predetermined direction does not comprise at least one direction of a receiver, called strong receiver, for which the estimated propagation channel corresponds to a propagation loss lower than the predetermined threshold.

Thus, the spatial coding of the distortion signal related to the clipping means that the distortion signal in question is not transmitted to the receivers closest to the AP incorporating the considered transmitter, i.e. the strong receivers.

In some embodiments, obtaining M clipped OFDM symbols includes a spatial precoding of N vectors of Ty modulation symbols delivering M vectors of N precoded symbols, each component of a given vector of N precoded symbols is intended to be conveyed by a corresponding subcarrier of a spatial component of the OFDM-type signal. The generation of an OFDM symbol implements, for each antenna of the transmitter, an inverse Fourier transformation applied to an input vector depending on a respective vector of N precoded symbols. The precoding implements a spatial precoding of said M spatial components based on said estimated propagation channel between the receivers and the transmitter to compensate for said propagation channel during the propagation of the OFDM-type signal to the receivers.

Thus, the useful data are transmitted to the concerned receivers, the propagation channel being compensated during the propagation of the OFDM-type signal from the considered transmitter to the concerned receivers.

In some embodiments, the modified spatial precoding operator is expressed as:

$${{\overline{H}}_{l , n} ( {\overline{H}}_{l , n}^{H} {\overline{H}}_{l , n} + {Γ}_{l} )}^{- 1}$$

with n being an index of said given subcarrier and l an identifier of the transmitter:
H̅_{l,n} the operator modeling the estimated propagation channel between the receivers and the transmitter

$${\overline{H}}_{l , n}^{H}$$

the operator modeling said estimated propagation channel between the transmitter and the receivers;

$${\overline{H}}_{l , n}^{H} {\overline{H}}_{l , n}$$

the receivers operator; and
Γₗ the diagonal type regularization operator.

Thus, the spatial coding operator implemented during the projection is based on a spatial precoding operator obtained from a zero-forcing type propagation channel equalization technique.

In some embodiments, at least one amplitude of a diagonal element of the regularization operator allowing controlling the level of distortion transmitted in the direction of a given weak receiver is inversely proportional to the power allocated to the given weak receiver. The allocated power is calculated depending on the propagation loss corresponding to the estimated propagation channel between the given weak receiver and the transmitter.

In some embodiments in which said at least one predetermined direction does not comprise at least one direction of a strong receiver, at least one amplitude of a diagonal element of the regularization operator allowing controlling the level of distortion transmitted in the direction of a given strong receiver is zero.

In some embodiments in which obtaining M clipped OFDM symbols comprises said spatial precoding, the modified spatial precoding operator is reduced, when the regularization operator is reduced to the zero operator, to an operator implemented during said precoding step.

In some embodiments, said at least one given subcarrier corresponds to a modulated subcarrier of the OFDM-type signal.

In some embodiments, the concatenation and the projection are implemented for a plurality of modulated subcarriers of the OFDM-type signal.

In some embodiments, the clipping implements a threshold δ beyond which an amplitude of the OFDM symbol is made constant equal to 8, the threshold is given by:

$$δ = \sqrt{{σ}^{2} ( \frac{{τ}_{p}}{{τ}_{s}} )}$$

with:
σ² a variance of the spatial components transmitted by the antennas of the transmitter;
τₚ a maximum number of different pilot signals present in an uplink frame implemented between the receivers and the transmitter; and
τₛ a number of weak receivers.

In some embodiments, the method is implemented iteratively. The updated OFDM symbol and the updated clipped OFDM symbol obtained during a given rank iteration correspond respectively to the OFDM symbol and the clipped OFDM symbol of a following rank iteration.

In some embodiments, the projection comprises a normalization of the vector of M reduction signals to make the vector of M reduction signals and the subcarrier error vector similar.

In some embodiments, the normalization implements a weighting of the vector of M reduction signals by a weighting factor & given by:

$${ϑ}_{l} = {𝔼}_{n} \{ \frac{{\sum }_{m} \vert {V}_{l , n} {ϵ}_{n} \vert \vert {ϵ}_{n} \vert}{{\sum }_{m} {\vert {V}_{l , n} {ϵ}_{n} \vert}^{2}} \}$$

with, n being an index of said given subcarrier, l an identifier of the transmitter and m an index indexing the antennas of the transmitter.
ϵₙ the subcarrier error vector; and
V_{l,n}ϵₙ the vector of M reduction signals.

The invention also relates to a computer program comprising program code instructions for implementing the method of reducing the peak-to-average power ratio as previously described, according to any one of the different embodiments thereof, when executed on a computer.

In one embodiment of the invention, a device is proposed for reducing the peak-to-average power ratio of an OFDM-type signal comprising N subcarriers. The signal results from stacking M spatial components that are each transmitted by a respective antenna of a radiofrequency transmitter to a plurality of receivers. Such a device comprises a reprogrammable computing machine or a dedicated computing machine configured to implement the steps of the method for reducing the peak-to-average power ratio described above (according to any one of the different aforementioned embodiments). Thus, the features and advantages of this device are the same as those of the corresponding steps of the method for reducing the peak-to-average power ratio previously described. Consequently, they are not detailed further.

In one embodiment of the invention, a radiofrequency transmitter is proposed comprising a device for reducing the peak-to-average power ratio described above (according to any one of the different aforementioned embodiments).

### LIST OF FIGURES

Other aims, features and advantages of the invention will appear more clearly on reading the following description, given by way of a simple illustrative, and not limiting, example in relation to the figures, among which:

FIG. 1a, described above in relation to the prior art, illustrates a radiocommunications network implementing APs according to a technology of the CF-mMIMO type;

FIG. 1b, described above in relation to the prior art, illustrates a radiocommunications network implementing APs according to a technology of the scalable CF-mMIMO type;

FIG. 2 represents different functional modules implemented in a transmitter of an AP according to an embodiment of the invention, such an AP being able to be implemented e.g. in the network of [FIG. 1a] or in the network of [FIG. 1b];

FIG. 3 represents an example of a device structure that can be implemented in the transmitter of [FIG. 2] and allowing the implementation of the steps of the method for reducing the peak-to-average power ratio of [FIG. 4] according to an embodiment of the invention;

FIG. 4 represents the steps of a method for reducing the peak-to-average power ratio of an OFDM-type signal according to an embodiment of the invention.

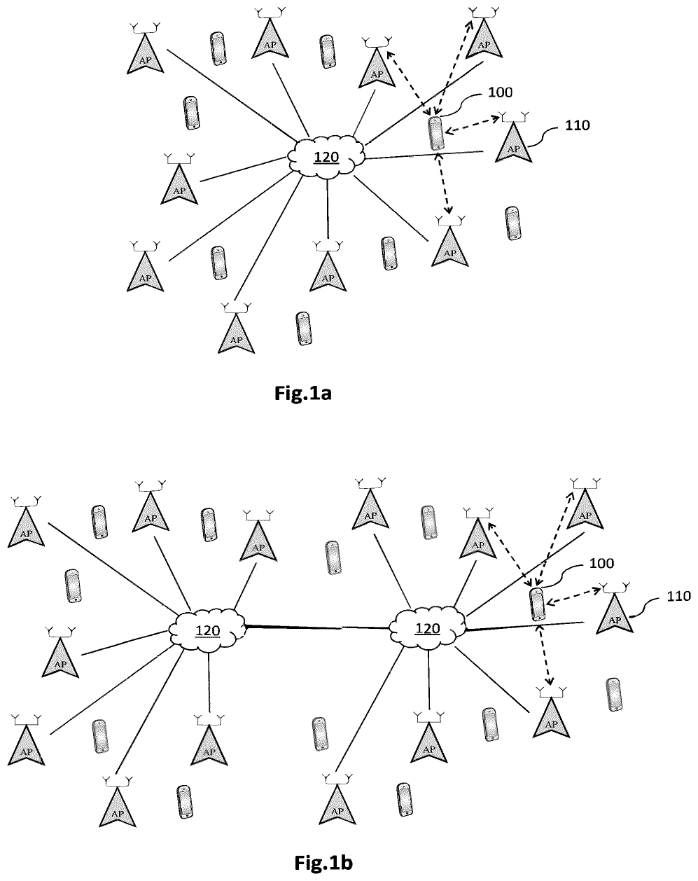

### DETAILED DESCRIPTION OF EMBODIMENTS OF THE INVENTION

The general principle of the invention is based on the use of a spatial coding of the distortion signal related to the clipping of the OFDM signal transmitted by an AP 110 so that the distortion signal in question is transmitted in one (or more) directions of a receiver 100w for which the estimated propagation channel, between the receiver 100w and the considered AP 110, corresponds to a propagation loss which is greater than a predetermined threshold.

Thus, the distortion signal is transmitted as a priority to the receivers 100w furthest from the considered AP 110. Indeed, it is likely that in a dense system in AP 110, such as in a system of the scalable CF-mMIMO type, such receivers 100w distant from the considered AP 110 are located in the vicinity of another AP 110. It is thus likely that the transmission of the distortion related to the clipping towards such receivers 100w will not penalize their performances, the latter also receiving their data via another AP 110. Moreover, the transmission of the distortion signal to receivers 100w connected to the considered AP 110 rather than in a direction in which no terminal 100 is present allows eliminating the problem of the absence of degrees of freedom available when the number of connected terminals 100 is greater than the number of transmit antennas of the considered AP 110. This technique is thus particularly adapted to a scalable CF-mMIMO type system.

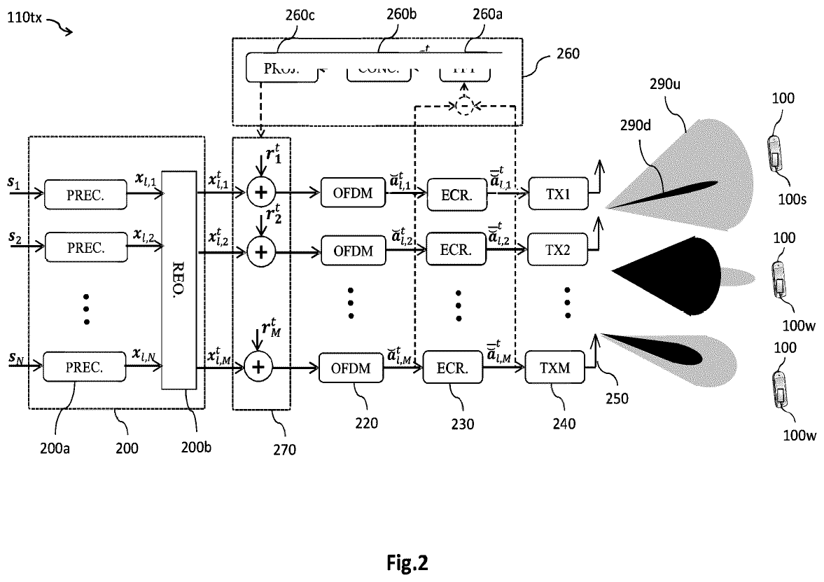

We now different functional modules implemented in a transmitter 110tx of an AP 110 are now presented, in relation to [FIG. 2], according to an embodiment of the invention.

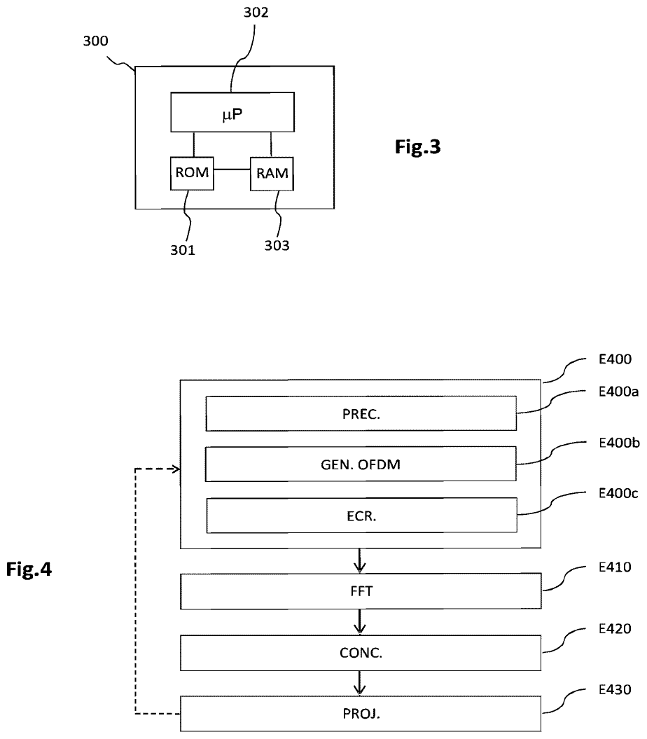

Such modules implement in particular the functionalities implemented in the method for reducing the peak-to-average power ratio of [FIG. 4]. In this manner, depending on the considered implementations, such modules can be software or hardware modules as described further below in relation to [FIG. 3].

Returning to [FIG. 2], the transmitter 110tx is configured to generate an OFDM-type signal comprising N subcarriers. More particularly, the signal in question from the superposition of M spatial components results each transmitted by a respective antenna 250 of the radiofrequency transmitter 110tx. The signal thus generated is transmitted to a plurality of receivers 100w, 100s, e.g. receivers of user terminals 100.

According to the present technique, the receivers 100w, 100s are differentiated according to the estimated propagation loss between the considered receiver 100w, 100s and the transmitter 110tx. More particularly:
some receivers 100w, called weak receivers, correspond to a propagation loss which is greater than a predetermined threshold. In other words, the weak receivers 100w are estimated, via the estimation of the propagation channel, as being the furthest from the transmitter 110tx; and
other receivers 100s, called strong receivers, correspond to a propagation loss which is lower than said predetermined threshold. In other words, the strong receivers 100s are estimated, via the propagation channel estimation, as being the closest to the transmitter 110tx.

Returning to [FIG. 2], the transmitter 110tx comprises a spatial precoding module 200 operating on N vectors s₁, . . . , s_{N} OF τₚ modulation symbols to deliver M vectors

$${x}_{l , 1}^{t} , … , {x}_{l , M}^{t}$$

of N precoded symbols. Each component of a given vector of N precoded symbols being intended to be carried by a corresponding subcarrier of a spatial component of the OFDM-type signal.

According to the present notations:
l represents an identifier of the AP 110, or equivalently of the transmitter 110tx; and
τₚ represents a maximum number of different pilot signals present in an uplink frame implemented between the terminals 100 implementing the receivers 100w, 100s and the AP 110 implementing the transmitter 110tx. The pilot signals in question allow estimating the propagation channel between the receivers 100w, 100s and the AP 110 in the uplink direction. For example, when the number K of receivers 100w, 100s connected to the AP 110 is greater than the maximum number of different pilot signals, Tp, the same channel is estimated for all receivers 100w, 100s using the same pilot signal. In this case, the same spatial precoding, as described below in relation to the module 200, is implemented for all receivers 100w, 100s using the same pilot signal. Indirectly, such an estimation of the propagation channel between the receivers 100w, 100s and the AP 110 in the uplink direction also allows estimating the propagation channel between the receivers 100w, 100s and the transmitter 110tx in the downlink direction, e.g. in a system of the TDD (for “Time-Division Duplex”) type in which the same frequency band is used for the uplink and the downlink.

More particularly, the module 200 implements a spatial precoding of the M spatial components of the OFDM-type signal based on the estimated propagation channel between the receivers 100w, 100s and the transmitter 110tx to compensate said propagation channel during the propagation of the OFDM-type signal to the receivers 100w, 100s.

For example, according to a zero-forcing equalization approach, it is sought to have for each vector s₁, . . . , sₙ of τₚ symbols to be transmitted, the same symbol vector received at the receivers 100w, 100s. In other words, it is sought to have, for the subcarrier of index n of the OFDM-type signal:

$${\overline{H}}_{l , n}^{H} {W}_{l , n} {s}_{n} = {s}_{n} \qquad [ Math . 1 ]$$

Where, l being an identifier of the transmitter 110tx:
W_{l,n} designates the spatial precoding operator to be determined; and

$${\overline{H}}_{l , n}^{H}$$

designates the operator modeling the estimated propagation channel between the transmitter 110tx and the receivers 100w, 100s, i.e. in the downlink direction.

The optimal solution to the equation [Math. 1] is given by:

$${W}_{l , n} = {{\overline{H}}_{l , n} ( {\overline{H}}_{l , n}^{H} {\overline{H}}_{l , n} )}^{- 1} \qquad [ Math . 2 ]$$

Where H̅_{l,n} designates the operator modeling the estimated propagation channel between the receivers 100w, 100s and the transmitter 110tx, i.e. in the uplink direction.

Indeed, it can be verified that:

$${\overline{H}}_{l , n}^{H} {W}_{l , n} = {\overline{H}}_{l , n}^{H} {{\overline{H}}_{l , n} ( {\overline{H}}_{l , n}^{H} {\overline{H}}_{l , n} )}^{- 1} = {I}_{{τ}_{p} , {τ}_{p}} \qquad [ Math . 3 ]$$

Where:
l_{τ}_{ₚ}_{,τ}_{ₚ} designates the identity matrix of rank τₚ; and

$${\overline{H}}_{l , n}^{H} {\overline{H}}_{l , n}$$

represents an operator, called receivers operator, of rank τₚ. More particularly, a diagonal element of given index of this receivers operator represents the propagation losses between the transmitter 110tx and the receiver(s) 100w, 100s using the pilot signal corresponding to the index considered on the uplink. The off-diagonal elements of this receivers operator represent the coupling between the receivers using the two pilot signals corresponding to the indices of the considered off-diagonal elements.

Returning to [FIG. 2], the module 200 implements N spatial coding modules 200a as such. Each of the N modules implements an operator processing a vector sₙ of τₚ symbols and delivers a vector x_{l,n} of M elements. The operator in question is for example the operator W_{l,n} defined by the equation [Math. 2]. However, in other embodiments, other equalization techniques than the zero-forcing technique are considered in order to obtain the spatial coding operator.

Returning to [FIG. 2], the module 200 also implements a module 200b for reorganizing the N vectors x_{l,1}, . . . x_{l,N} of M elements in order to deliver the M vectors

$${x}_{l , 1}^{t} , ... , {x}_{l , M}^{t}$$

of N precoded symbols, each vector

$${x}_{l , m}^{t}$$

being associated with an antenna 250 of the transmitter 110tx. More particularly, the n th element of the vector

$${x}_{l , m}^{t}$$

corresponds to the mth element of the vector x_{l,n}, n an integer ranging from 1 to N and m an integer ranging from 1 to M.

The transmitter 110tx comprises a module 270 delivering, for an antenna 250 indexed m of the transmitter 110tx, an input vector resulting from the sum between, on the one hand, the vector

$${x}_{l , m}^{t}$$

of N elements and, on the other hand, a vector

$${r}_{m}^{t}$$

of N elements comprising reduction signals each being applied to a corresponding subcarrier of the spatial component transmitted by said antenna indexed m of the transmitter 110tx. Such an input vector is obtained for each of the M antennas 250 of the transmitter 110tx. The obtaining of the vectors

$${r}_{1}^{t} , ... , {r}_{M}^{t}$$

by the module 260 is detailed further below.

The transmitter 110tx comprises, for an antenna 250 indexed m of the transmitter 110tx, m an integer ranging from 1 to M, a module 220 for generating an OFDM symbol

$${{a}^{⌣}}_{l , m}^{t}$$

of N samples from the corresponding input vector of N elements. Such an OFDM symbol is obtained for each of the M antennas 250 of the transmitter 110tx. A given generation module 220 implements for example the inverse Fourier transform of a corresponding input vector. The transmitter 110tx comprises, for an antenna 250 indexed m of the transmitter 110tx, m an integer ranging from 1 to M, a module 230 for clipping the OFDM symbol

$${{a}^{⌣}}_{l , m}^{t}$$

delivering a corresponding clipped OFDM symbol

$${\overline{{a}^{⌣}}}_{l , m}^{t} .$$

For example, clipping implements a threshold beyond which an amplitude of the OFDM symbol

$${{a}^{⌣}}_{l , m}^{t}$$

is made constant equal to δ. For example, according to some implementations the threshold is given by:

$$δ = \sqrt{{σ}^{2} ( \frac{{τ}_{p}}{{τ}_{s}} )} \qquad [ Math . 4 ]$$

with:
σ² a variance of the spatial components transmitted by the antennas 250 of the transmitter 110tx;
τₚ the maximum number of pilot signals as defined above; and
τₛ the number of weak receivers 100w.

The threshold δ as defined by the equation [Math. 4] allows obtaining optimal performances with regard to the reduction of the peak-to-average power ratio.

Returning to [FIG. 2], such a clipped OFDM symbol

$${\overline{{a}^{⌣}}}_{l , m}^{t}$$

is obtained for each of the M antennas 250 of the transmitter 110tx.

Moreover, the transmitter 110tx comprises, for an antenna 250 indexed m of the transmitter 110tx, m an integer ranging from 1 to M, a transmission module 240 delivering the spatial component transmitted by the antenna in question. Such a transmission module 240 implements the known, mixed or analogous functionalities of a transmitter. These are for example the digital/analog conversion, filtering, frequency conversion and power amplification functionalities. Such a spatial component is obtained for each of the M antennas 250 of the transmitter 110tx. In order to obtain the vectors

$${r}_{1}^{t} , ... , {r}_{M}^{t} ,$$

the module 260 comprises a Fourier transform module 260a. More particularly, for an antenna 250 indexed m of the transmitter 110tx, m an integer ranging from 1 to M, the module 260a implements a Fourier transform of an error vector depending on a difference between the clipped OFDM symbol

$${\overline{{a}^{⌣}}}_{l , m}^{t}$$

and the OFDM symbol

$${{a}^{⌣}}_{l , m}^{t} ,$$

delivering a transformed error vector

$${ϵ}_{m}^{t}$$

of N error signals. The Fourier transform is repeated for each antenna of the transmitter delivering M transformed error vectors

$${ϵ}_{M}^{t}$$

of N error signals.

The module 260 comprises a module 260b for concatenating the error signals associated with the subcarrier of index n in each of the M transformed error vectors

$${ϵ}_{1}^{t} , … , {ϵ}_{M}^{t}$$

delivering an error vector, called subcarrier error vector ϵₙ, of M error signals, each error signal in the subcarrier error vector ϵₙ being associated with a respective antenna.

The module 260 comprises a module 260c for projecting the subcarrier error vector Enby delivering a vector of M peak-to-average power ratio reduction signals associated with the subcarrier of index n. Each peak-to-average power ratio reduction signal in the vector of M peak-to-average power ratio reduction signals being associated with a respective antenna.

Furthermore, the modules 260b and 260c are implemented for all or part of the subcarriers of the OFDM-type signal generated and transmitted by the transmitter 110tx as described below in relation to [FIG. 4]. For example, the modules 260b and 260c are implemented to obtain the vectors of peak-to-average power ratio reduction signals associated with the active subcarriers of the OFDM-type signal, the peak-to-average power ratio reduction signals associated with the non-active subcarriers of the OFDM-type signal being set to zero.

Regardless of the values of the peak-to-average power ratio reduction signals, the vectors

$${r}_{1}^{t} , … , {r}_{M}^{t}$$

are obtained by rearranging the vectors of M peak-to-average power ratio reduction signals associated with the different subcarriers. More particularly, a vector of N elements vectors

$${r}_{m}^{t} ,$$

m an integer ranging from 1 to M, comprises the reduction signals applying to each corresponding subcarrier of the spatial component transmitted by the antenna indexed m of the transmitter 110tx.

More particularly, the spatial coding implemented by the module 200 allows compensation for the propagation channel during the propagation of the OFDM-type signal from the transmitter 110tx to the different receivers 100w, 100s connected to the AP 110. Conversely, the projection implemented in the module 260c implements, for the concerned subcarriers, a spatial coding of the M error signals of the subcarrier error vector ϵₙ, based on the estimated propagation channel, so that the distortion signal related to the difference between the clipped OFDM symbols

$${\overline{{a}^{⌣}}}_{l , m}^{t}$$

and the OFDM symbols

$${{a}^{⌣}}_{l , m}^{t}$$

is transmitted by the transmitter 110tx in at least one direction of a weak receiver 100w. Thus, the distortion signal 290d is transmitted in at least one direction from a weak receiver 100w while the signal 290u conveying the useful data is transmitted to all connected receivers 100w, 100s.

An example of a structure of an electronic device 300 allowing the execution of the steps of the method for reducing the peak-to-average power ratio of [FIG. 4], is now presented, in relation to [FIG. 3], according to one embodiment of the invention. The device 300 allows in particular the implementation of the corresponding modules described above in relation to [FIG. 2].

More particularly, the device 300 comprises a random-access memory 303 (for example a RAM memory), a processing unit 302 equipped for example with a processor, and controlled by a computer program stored in a read-only memory 301 (for example a ROM memory or a hard disk). At initialization, the code instructions of the computer program are for example loaded into the random access memory 303 before being executed by the processor of the processing unit 302.

This [FIG. 3] illustrates only one particular manner, among several possible ones, of producing the device 300 so that it performs certain steps of the method of reducing the peak-to-average power ratio of [FIG. 4] (according to any one of the embodiments described below in relation to [FIG. 4]). Indeed, these steps can be performed indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 300 is produced with a reprogrammable computing machine, the corresponding program (that is to say the sequence of instructions) might be stored in a removable storage medium (such as for example a CD-ROM, a DVD-ROM, a USB key) or not, this storage medium being partially or totally readable by a computer or a processor.

In some embodiments, the device 300 is included in a transmitter 110tx, e.g. a transmitter 110tx of an AP 110.

The steps of a method for reducing the peak-to-average power ratio of an OFDM-type signal are now presented, in relation to [FIG. 4], according to an embodiment of the invention.

More particularly, during a step E400, the device 300 executes an obtaining of M clipped OFDM symbols

$${\overline{{a}^{⌣}}}_{l , 1}^{t} , … , {\overline{{a}^{⌣}}}_{l , M}^{t}$$

each intended to be a temporal portion of a spatial component transmitted by a respective antenna 250 of the transmitter 110tx.

More particularly, the step E400 comprises a step E400a of spatial precoding of N vectors s₁, . . . , s_{N} of τₚ modulation symbols to deliver M vectors

$${x}_{l , 1}^{t} , … , {x}_{l , M}^{t}$$

of N precoded symbols. Each component of a given vector of N precoded symbols being intended to be conveyed by a corresponding subcarrier of a spatial component of the OFDM-type signal. More particularly, the step E400a implements the functionalities of the module 200 described above in relation to [FIG. 2]. In particular, the spatial precoding of the M spatial components is based on the estimated propagation channel between the receivers 100w, 100s and the transmitter 110tx to compensate for the propagation channel during the propagation of the OFDM-type signal to the receivers 100w, 100s. For example, the spatial precoding implements an operator processing each vector s_{N}, n an integer ranging from 1 to N, of τₚ symbols and delivers a vector ximof M elements. The operator in question is for example the operator W_{l,m} 10 defined by the equation [Math. 2]. However, in other embodiments, other equalization techniques than the zero-forcing technique are considered in order to obtain the spatial coding operator.

Returning to [FIG. 4], step E400 comprises, for at least one antenna 250 indexed m of the transmitter 110tx, m an integer ranging from 1 to M:
a step E400b of generating an OFDM symbol

$${\overline{{a}^{⌣}}}_{l , m}^{t}$$

by implementing an inverse Fourier transformation applied to the input vector depending on the vector

$${x}_{l , m}^{t}$$

of N precoded symbols. Each component of the input vector is intended to be conveyed by a corresponding subcarrier of a spatial component of the OFDM-type signal; and
a step E400c of clipping the OFDM symbol

$${\overline{{a}^{⌣}}}_{l , m}^{t}$$

delivering a clipped OFDM symbol

$${\overline{{a}^{⌣}}}_{l , m}^{t}$$

intended to be a temporal portion of the spatial component transmitted by said antenna 250 indexed m;
Step E400b and step E400c which are repeated for each antenna 250 of the transmitter 110tx deliver M clipped OFDM symbols

$${\overline{{a}^{⌣}}}_{l , 1}^{t} , … , {\overline{{a}^{⌣}}}_{l , M}^{t} .$$

More particularly, step E400b implements the functionalities of the module 220 described above in relation to [FIG. 2] and step E400c implements the functionalities of the module 230 described above in relation to [FIG. 2].

In particular, as described above in relation to [FIG. 2], the input vector associated with the antenna 250 indexed m results from the sum between, on the one hand, the vector

$${x}_{l , m}^{t}$$

of N elements and, on the other hand, a vector

$${r}_{l , m}^{t}$$

of N elements comprising reduction signals each applying to a corresponding subcarrier of the spatial component transmitted by said antenna indexed m of the transmitter 110tx. Such an input vector is obtained for each of the M antennas 250 of the transmitter 110tx. Obtaining the vectors

$${r}_{1}^{t} , … , {r}_{M}^{t}$$

is detailed further below in relation to steps E410, E420 and E430.

As described above in relation to [FIG. 2], the addition of the reduction signals to the input elements of the inverse Fourier transform implemented during step E400b allows the transmission of the distortion signal related to the difference between the clipped OFDM symbol

$${\overline{{a}^{⌣}}}_{l , m}^{t}$$

and the OFDM symbols

$${{a}^{⌣}}_{l , m}^{t}$$

in at least one direction of a weak receiver 100w.

Moreover, in some embodiments, the spatial precoding step E400a is not implemented. Indeed, the transmission of the distortion signal related to the clipping of the OFDM signal transmitted by the AP 110 in one (or more) direction(s) of a weak 100W terminal is obtained independently of such a spatial precoding of the useful data. Only the addition of the reduction signals to the input elements of inverse the Fourier transform implemented during step E400b in order to generate the OFDM symbols is required to obtain this effect. In such embodiments, said inverse Fourier transformation implemented during step E400b is applied to an input vector that is a direct function of vectors of N modulation symbols and not a function of the vectors

$${x}_{l , m}^{t}$$

of N precoded symbols.

Returning to [FIG. 4], in order to obtain the vectors

$${r}_{1}^{t} , … , {r}_{M}^{t}$$

comprising the reduction signals, the device 300 executes, for at least one antenna 250 indexed m of the transmitter 110tx, m an integer ranging from 1 to M, a step E410 of Fourier transformation of an error vector depending on a difference between the clipped OFDM symbol

$${\overline{{a}^{⌣}}}_{l , m}^{t}$$

and the OFDM symbol

$${{a}^{⌣}}_{l , m}^{t}$$

associated with the antenna 250 indexed m, delivering a transformed error vector

$${ϵ}_{m}^{t}$$

of N error signals. The Fourier transformation is repeated for each antenna of the transmitter delivering M transformed error vectors

$${ϵ}_{1}^{t} , … , {ϵ}_{M}^{t}$$

of N error signals.

More particularly, step E410 implements the functionalities of the module 260a described above in relation to [FIG. 2].

Returning to [FIG. 4], the device 300 executes, for at least one subcarrier of index n, n an integer ranging from 1 to N:
a step E420 of concatenating the error signals associated with the given subcarrier in each of the M transformed error vectors

$${ϵ}_{1}^{t} , … , {ϵ}_{M}^{t}$$

delivering the subcarrier error vector ϵₙ, of M error signals. Each error signal in the subcarrier error vector being associated with a respective antenna; and
a step E430 of projecting the subcarrier error vector ϵₙ delivering a vector of M peak-to-average power ratio reduction signals associated with the subcarrier of index n. Each peak-to-average power ratio reduction signal in the vector of M reduction signals is associated with a respective antenna.

More particularly, during step E430, the projection implements a spatial coding of the M error signals of the subcarrier error vector ϵₙ based on the estimated propagation channel between the receivers 100w, 100s and the transmitter 110tx so that the distortion signal related to the difference between the clipped OFDM symbols

$${\overline{{a}^{⌣}}}_{l , 1}^{t} , … , {\overline{{a}^{⌣}}}_{l , M}^{t}$$

and the OFDM symbols

$${{a}^{⌣}}_{l , 1}^{t} , … , {{a}^{⌣}}_{l , M}^{t}$$

is transmitted by the transmitter 110tx in at least one direction of a low 100w.

According to the considered embodiments, step E420 and step E430 are implemented for all or part of the subcarriers of the signal OFDM-type generated and transmitted by the transmitter 110tx. For example, step E420 and step E430 are implemented to obtain the vectors of M peak-to-average power ratio reduction signals associated with the active subcarriers of the OFDM-type signal, the peak-to-average power ratio reduction signals associated with the non-active subcarriers of the OFDM-type signal being set to zero. For example, step E420 and step E430 are not implemented for the non-active subcarriers of the OFDM-type signal.

Moreover, in some embodiments, said at least one predetermined direction does not comprise at least one direction of a strong receiver 100s.

In some embodiments, during step E430, the projection implements an operator V_{l,n} of the spatial coding being expressed as the identity operator from which a standardized operator of modified spatial coding is subtracted. The standardized operator of modified spatial coding depends on a composition between a modified spatial precoding operator and the operator modeling the estimated propagation channel between the transmitter 110tx and the receivers 100w, 100s.

The modified spatial precoding operator depends on a receivers operator, from which a regularization operator is subtracted. The receivers operator, according to the definition given above in relation to [FIG. 2], depends on a composition between the operator modeling the estimated propagation channel between the receivers 100w, 100s and the transmitter 100tx (i.e. in the uplink direction) and the operator modeling the estimated propagation channel between the transmitter 100tx and the receivers 100w, 100s (i.e. in the downlink direction). Each diagonal element of the receivers operator is representative of a power received by the corresponding receiver. The regularization operator is of the diagonal type, each diagonal element of the regularization operator is associated with a corresponding receiver 100w, 100s. An amplitude of each diagonal element of the regularization operator allows controlling the level of distortion related to the difference between the OFDM symbols

$${{a}^{⌣}}_{l , 1}^{t} , … , {{a}^{⌣}}_{l , M}^{t}$$

and the and the clipped OFD OFDM symbols

$${\overline{{a}^{⌣}}}_{l , 1}^{t} , … , {\overline{{a}^{⌣}}}_{l , m}^{t}$$

transmitted in the direction of the corresponding receiver 100w, 100s. The modified spatial precoding operator is reduced, when the regularization operator reduces to the zero operator, to a spatial precoding operator, e.g. as implemented in the known MIMO techniques.

For example, in some embodiments, at least one amplitude of a diagonal element of the regularization operator allowing controlling the level of distortion transmitted in the direction of a given weak receiver 100w is inversely proportional to the power allocated, by the transmitter 110tx, to the given 100w weak receiver within the OFDM-type signal. Such a power is e.g. calculated depending on the propagation loss corresponding to the estimated propagation channel between the given weak receiver 100w and the transmitter 110tx. Such a calculation of the allocated power is performed e.g. according to a power allocation mechanism implemented at the transmitter 110tx.

Similarly, in some embodiments, at least one amplitude of a diagonal element of the regularization operator allowing controlling the level of distortion transmitted in the direction of a given strong receiver 100s is zero.

For example, in some embodiments, the modified spatial precoding operator is reduced, when the regularization operator is reduced to the zero operator, to the operator implemented during the precoding step E400a.

More particularly, in the case taken as an illustrative example above in connection with the description of [FIG. 2] of a spatial precoding according to a zero-forcing equalization channel equalization approach, the modified spatial precoding operator is expressed as:

$${{\overline{H}}_{l , n} ( {\overline{H}}_{l , n}^{H} {\overline{H}}_{l , n} + {Γ}_{l} )}^{- 1} \qquad [ Math . 5 ]$$

with n being an index of said given subcarrier and l an identifier of the transmitter:
H̅_{l,n} the operator modeling said estimated propagation channel between the receivers 100w, 100s and the transmitter 110tx, in the upstream direction;

$${\overline{H}}_{l , n}^{H}$$

the operator modeling the estimated propagation channel between the transmitter 110tx and the receivers 100w, 100s, i.e. in the downstream direction;

$${\overline{H}}_{l , n}^{H} {\overline{H}}_{l , n}$$

the receivers operator; and
Γₗ the regularization operator.

Thus, the operator V_{l,n} of the spatial coding is expressed in this case according to:

$${V}_{l , n} = {I}_{M , M} - {{\overline{H}}_{l , n} ( {\overline{H}}_{l , n}^{H} {\overline{H}}_{l , n} + {Γ}_{l} )}^{- 1} {\overline{H}}_{l , n}^{H} \qquad [ Math . 6 ]$$

Thus, in the case where the regularization operator Γₗ is zero, the operator V_{l,n} is reduced to:

$${V}_{l , n} = {I}_{M , M} - {{\overline{H}}_{l , n} ( {\overline{H}}_{l , n}^{H} {\overline{H}}_{l , n} )}^{- 1} {\overline{H}}_{l , n}^{H} \qquad [ Math . 7 ]$$

It can then be verified that:

$${\overline{H}}_{l , n}^{H} {V}_{l , n} = {\overline{H}}_{l , n}^{H} - {\overline{H}}_{l , n}^{H} {{\overline{H}}_{l , n} ( {\overline{H}}_{l , n}^{H} {\overline{H}}_{l , n} )}^{- 1} {\overline{H}}_{l , n}^{H} = {0}_{{τ}_{p} , M} \qquad [ Math . 8 ]$$

In other words, the construction as described above of the operator V_{l,n} implemented during step E430 is such that no distortion signal related to the difference between the clipped OFDM symbols

$${\overline{{a}^{⌣}}}_{l , m}^{t}$$

and the OFDM symbols

$${{a}^{⌣}}_{l , m}^{t}$$

is transmitted in the direction of a receiver 100w, 100s corresponding to a diagonal element of the regularization operator Γₗ which is zero. On the contrary, a non-zero amplitude of a given diagonal element of the regularization operator allows transmitting the distortion in question in the direction of the corresponding receiver 100w, 100s and controlling its level. This result applies independently of the nature of the spatial precoding operator on which the modified spatial precoding operator is based, i.e. whether the spatial precoding operator is based on a zero-forcing type propagation channel equalization technique, as considered as an example above, or on another equalization technique.

Furthermore, in some embodiments, the method for reducing the peak-to-average power ratio (according to any of the embodiments described above) is implemented iteratively.

An OFDM symbol and the clipped OFDM symbol obtained during a given rank iteration being based on an input vector depending on reduction signals determined, via the execution of steps E410, E420 and E430, from an OFDM symbol and a clipped OFDM symbol of a previous rank iteration.

For example, the first iteration, the during reduction signals are initialized to a zero value.

In some embodiments, during step E430, the projection comprises a normalization of the vector of M peak-to-average power ratio reduction signals to make said vector of M peak-to-average power ratio reduction signals and the subcarrier error vector similar. Such normalization allows in particular a faster convergence when the method is implemented in iterative form.

For example, the normalization implements a weighting of the vectors of M signals for reducing the peak-to-average power ratio by a weighting factor ϑ₁ given by:

$${ϑ}_{l} = {𝔼}_{n} \{ \frac{{\sum }_{m} \vert {V}_{l , n} {ϵ}_{n} \vert \vert {ϵ}_{n} \vert}{{\sum }_{m} {\vert {V}_{l , n} {ϵ}_{n} \vert}^{2}} \} \qquad [ Math . 9 ]$$

with, n being an index of said given subcarrier, l an identifier of the transmitter 110tx and m an index indexing the antennas of the transmitter 110tx.
ϵₙ the subcarrier error vector; and
V_{l,n}ϵₙ the vector of M reduction signals.

1. A method for reducing a peak-to-average power ratio of an OFDM-type signal comprising N subcarriers, said signal resulting from stacking M spatial components that are each transmitted by a respective antenna of a radiofrequency transmitter to a plurality of receivers, wherein an electronic device executes;
obtaining M clipped OFDM symbols, each to be a temporal portion of a spatial component transmitted by a respective antenna of the transmitter, said obtaining comprising, for at least one antenna of the transmitter:
generating an OFDM symbol by implementing an inverse Fourier transform applied to an input vector depending on modulation symbols, each component of the input vector to be conveyed by a corresponding subcarrier of a spatial component of the OFDM-type signal; and
clipping the OFDM symbol delivering a clipped OFDM symbol intended to be a temporal portion of the spatial component transmitted by said antenna, said generating and said clipping repeated for each antenna of the transmitter delivering said M clipped OFDM symbols,
wherein the electronic device executes, for at least one given antenna of the transmitter:
a Fourier transformation of an error vector depending on a difference between the clipped OFDM symbol and the OFDM symbol associated with the given antenna, delivering a transformed error vector of N error signals, said Fourier transformation, which is repeated for each antenna of the transmitter, delivering M transformed error vectors of N error signals,
wherein the electronic device executes, for at least one given subcarrier:
a concatenation of the error signals associated with the given subcarrier in each of the M transformed error vectors delivering an error vector, called subcarrier error vector, of M error signals, each error signal in the subcarrier error vector being associated with a respective antenna; and
a projection of said subcarrier error vector delivering a vector of M signals for reducing the peak-to-average power ratio associated with the given subcarrier, each peak-to-average power ratio reduction signal in said vector of M reduction signals being associated with a respective antenna;
wherein the electronic device executes a new implementation of said obtaining of M clipped OFDM symbols to generate M updated clipped OFDM symbols, wherein said generation, for at least one antenna of the transmitter, of an OFDM symbol implements said inverse Fourier transformation applied to an updated input vector, the updated input vector being a function of N new modulation symbols, the peak-to-average power ratio reduction signal of the vector of M reduction signals corresponding to said antenna and associated with the given subcarrier being added to the new modulation symbol intended to be conveyed by said given subcarrier in the updated input vector;
wherein said projection implements a spatial coding of said M error signals of the subcarrier error vector based on an estimated propagation channel between said receivers and said transmitter so that the distortion signal related to the difference between the clipped OFDM symbols and the OFDM symbols is transmitted by the transmitter in at least one direction of a receiver, called a weak receiver, for which the estimated propagation channel corresponds to a propagation loss which is greater than a predetermined threshold,
wherein said projection implements an operator V_{l,n} of said spatial coding being expressed as the identity operator from which a normalized modified spatial coding operator is subtracted,
the normalized modified spatial coding operator being a function of a composition between a modified spatial precoding operator and an operator modeling said estimated propagation channel between said transmitter and said receivers,
the modified spatial precoding operator being a function of an operator, called a receivers operator, from which a regularization operator is subtracted,
the receivers operator being a function of a composition between an operator modeling said estimated propagation channel between said receivers and said transmitter and said operator modeling an estimated propagation channel between said transmitter and said receivers, each diagonal element of said receivers operator being representative of a power received by the corresponding receiver,
the regularization operator being of a diagonal type, each diagonal element of said regularization operator being associated with a corresponding receiver, an amplitude of each diagonal element of said regularization operator allowing controlling of a level of distortion related to the difference between the OFDM symbols and the clipped OFDM symbols transmitted in the direction of the corresponding receiver.

2. The method according to claim 1, wherein said at least one predetermined direction does not comprise at least one direction of a receiver, called a strong receiver, for which the estimated propagation channel corresponds to a propagation loss lower which is than said predetermined threshold.

3. The method according to claim 1, wherein said obtaining of M clipped OFDM symbols comprises:
a spatial precoding of N vectors of τₚ modulation symbols delivering M vectors of N precoded symbols, each component of a given vector of N precoded symbols being intended to be conveyed by a corresponding subcarrier of a spatial component of the OFDM-type signal,
said generation of an OFDM symbol implementing, for each antenna of the transmitter, an inverse Fourier transformation applied to an input vector depending on a respective vector of N precoded symbols, and
said precoding implementing a spatial precoding of said M spatial components based on said estimated propagation channel between said receivers and said transmitter to compensate for said propagation channel during the propagation of said OFDM-type signal to said receivers.

4. The method according to claim 1, wherein the modified spatial precoding operator is expressed as:
$${{\overline{H}}_{l , n} ( {\overline{H}}_{l , n}^{H} {\overline{H}}_{l , n} + {Γ}_{l} )}^{- 1}$$
with n being an index of said given subcarrier and l an identifier of the transmitter:
H̅_{l,n} being said operator modeling said estimated propagation channel between said receivers and said transmitter;
$${\overline{H}}_{l , n}^{H}$$
being said operator modeling said estimated propagation channel between said transmitter and said receivers;
$$[ [ - ] ] {\overline{H}}_{l , n}^{H} {\overline{H}}_{l , n}$$
being said receivers operator; and
Γₗ being said diagonal type regularization operator.

5. The method according to claim 1, wherein at least one amplitude of a diagonal element of said regularization operator allowing controlling the level of distortion transmitted in the direction of a given weak receiver is inversely proportional to the power allocated to the given weak receiver, the allocated power being calculated depending on the propagation loss corresponding to the estimated propagation channel between the given weak receiver and the transmitter.

6. The method according to claim 2, wherein at least one amplitude of a diagonal element of said regularization operator allowing controlling the level of distortion transmitted in the direction of a given strong receiver is zero.

7. The method according to claim 3, wherein the modified spatial precoding operator is reduced, when the regularization operator is reduced to the zero operator, to an operator implemented during said precoding step.

8. The method according to claim 1, wherein said at least one given subcarrier corresponds to a modulated subcarrier of said OFDM-type signal.

9. The method according to claim 1, wherein said clipping implements a threshold δ beyond which an amplitude of said OFDM symbol is made constant equal to δ, said threshold being given by:
$$δ = \sqrt{{σ}^{2} ( \frac{{τ}_{p}}{{τ}_{s}} )}$$
with:
σ² being a variance of the spatial components transmitted by the antennas of the transmitter;
τₚ being a maximum number of different pilot signals present in an uplink frame implemented between the receivers and the transmitter; and
τₛ being a number of weak receivers.

10. The method according to claim 1, said method being implemented iteratively, the updated OFDM symbol and the updated clipped OFDM symbol obtained during a given rank iteration corresponding respectively to the OFDM symbol and the clipped OFDM symbol of a following rank iteration.

11. The method according to claim 1, wherein said projection comprises a normalization of said vector of M reduction signals to make said vector of M reduction signals and said subcarrier error vector similar.

12. The method according to claim 11, wherein said normalization implements a weighting of said vector of M reduction signals by a weighting factor ϑ₁ given by:
$${ϑ}_{l} = {𝔼}_{n} \{ \frac{{\sum }_{m} \vert {V}_{l , n} {ϵ}_{n} \vert \vert {ϵ}_{n} \vert}{{\sum }_{m} {\vert {V}_{l , n} {ϵ}_{n} \vert}^{2}} \}$$
with, n being an index of said given subcarrier, l being an identifier of the transmitter and m an index indexing the antennas of the transmitter,
ϵₙ being said subcarrier error vector; and
V_{l,n}ϵₙ being said vector of M reduction signals.

13. A computer program product comprising a non-transitory computer-readable medium storing program code instructions for implementing the method according to claim 1, when said program is executed on a computer.

14. An electronic device for reducing a peak-to-average power ratio of an OFDM-type signal comprising N subcarriers, said signal resulting from stacking M spatial components that are each transmitted by a respective antenna of a radiofrequency transmitter to a plurality of receivers, said electronic device comprising:
a reprogrammable computing machine or a dedicated computing machine configured to perform an obtaining of M clipped OFDM symbols, each to be a temporal portion of a spatial component transmitted by a respective antenna of the transmitter, said obtaining comprising, for at least one antenna of the transmitter:
generating an OFDM symbol by implementing an inverse Fourier transform applied to an input vector depending on modulation symbols, each component of the input vector being intended to be conveyed by a corresponding subcarrier of a spatial component of the OFDM-type signal; and
a clipping of the OFDM symbol delivering a clipped OFDM symbol intended to be a temporal portion of the spatial component transmitted by said antenna, said generation and said clipping being repeated for each antenna of the transmitter delivering said M clipped OFDM symbols,
wherein said reprogrammable computing machine or said dedicated computing machine is configured to perform, for at least one given antenna of the transmitter:
a Fourier transformation of an error vector depending on a difference between the clipped OFDM symbol and the OFDM symbol associated with the given antenna, delivering a transformed error vector of N error signals, said Fourier transformation, which is repeated for each antenna of the transmitter, delivering M transformed error vectors of N error signals,
wherein said reprogrammable computing machine or said dedicated computing machine is configured to perform, for at least one given subcarrier:
a concatenation of the error signals associated with the given subcarrier in each of the M transformed error vectors delivering an error vector, called subcarrier error vector, of M error signals, each error signal in the subcarrier error vector being associated with a respective antenna; and
a projection of said subcarrier error vector delivering a vector of M signals for reducing the peak-to-average power ratio associated with the given subcarrier, each peak-to-average power ratio reduction signal in said vector of M reduction signals being associated with a respective antenna;
wherein said reprogrammable computing machine or said dedicated computing machine is further configured to perform a new implementation of said obtaining of M clipped OFDM symbols to generate M updated clipped OFDM symbols, wherein said generation, for at least one antenna of the transmitter, of an OFDM symbol implements said inverse Fourier transformation applied to an updated input vector, the updated input vector being a function of N new modulation symbols, the peak-to-average power ratio reduction signal of the vector of M reduction signals corresponding to said antenna and being associated with the given subcarrier being added to the new modulation symbol intended to be conveyed by said given subcarrier in the updated input vector;
wherein said projection implements a spatial coding of said M error signals of the subcarrier error vector based on an estimated propagation channel between said receivers and said transmitter so that the distortion signal related to the difference between the clipped OFDM symbols and the OFDM symbols is transmitted by the transmitter in at least one direction of a receiver, called a weak receiver, for which the estimated propagation channel corresponds to a propagation loss which is greater than a predetermined threshold,
wherein said projection implements an operator V_{l,n} of said spatial coding being expressed as the identity operator from which a normalized modified spatial coding operator is subtracted,
the normalized modified spatial coding operator being a function of a composition between a modified spatial precoding operator and an operator modeling said estimated propagation channel between said transmitter and said receivers,
the modified spatial precoding operator being a function of an operator, called a receivers operator, from which a regularization operator is subtracted,
the receivers operator being a function of a composition between an operator modeling said estimated propagation channel between said receivers and said transmitter and said operator modeling an estimated propagation channel between said transmitter and said receivers, each diagonal element of said receivers operator being representative of a power received by the corresponding receiver,
the regularization operator being of a diagonal type, each diagonal element of said regularization operator being associated with a corresponding receiver, an amplitude of each diagonal element of said regularization operator allowing controlling the level of distortion related to the difference between the OFDM symbols and the clipped OFDM symbols transmitted in the direction of the corresponding receiver.

15. A radiofrequency transmitter comprising the device according to claim 14.
